(19) United States
(12) Patent Application Publication
(10) Pub. No.: US 2008/0186179 A1
(43) Pub. Date: Aug. 7, 2008

(54) Active marketing devices and systems for radio frequency identification

(75) Inventor: Wei-Chun Huang, Taipei City (TW)

Correspondence Address: Joe McKinney Muncy, PO Box 1364, Fairfax, VA, 22038-1364, US

(73) Assignee: Jog Technology Corp.

(21) Appl. No.: 11/826,342

(22) Filed: Jul. 13, 2007

(30) Foreign Application Priority Data
Feb. 2, 2007 (TW) 96104189

(51) Int. Cl. G08B 13/14

(52) U.S. Cl. 340/572.1

(57) ABSTRACT

An active marketing device for radio frequency identification (RFID). An exhibition device is disposed on an exhibition platform. A RFID tag on the exhibition device registers identification data corresponding to the exhibition device, and outputs a radio frequency signal corresponding to the identification data. A RFID reader detects movement of the exhibition device according to the radio frequency signal, reads the identification data of the RFID tag, and outputs device status information indicating the movement and the identification data of the exhibition device. A central processing unit obtains a device name, movement duration and movement frequency, and multimedia information corresponding to the exhibition device according to the device status information. A display device displays the multimedia information corresponding to the exhibition device.

### BACKGROUND OF THE INVENTION

1. Field of the Invention

The invention relates to active marketing, and more particularly to active marketing devices and systems using radio frequency (RF) identification.

2. Description of the Related Art

Generally, display devices are used to exhibit products at hyper markets or exhibitions. The display device comprises a plurality of display cabinets showing electronic devices such as cell phones or digital cameras. The outward appearance of the display devices provides the features of the displayed products to attract customers' attention, allowing customers to select specific products. However, the conventional display devices cannot capture customer preferences for the displayed products.

In addition, some conventional display devices further comprise liquid crystal displays (LCDs) and audio devices broadcasting fixed multimedia advertisements for propagation. However, the LCDs and audio devices broadcast only a minimum of multimedia advertisements and lack interaction with the customer.

### BRIEF SUMMARY OF INVENTION

Active marketing devices and systems are provided. An exemplary embodiment of an active marketing device for radio frequency identification (RFID) comprises an exhibition platform, an exhibition device disposed on the exhibition platform, a RFID tag on the exhibition device registering identification data corresponding to the exhibition device and outputting a radio frequency signal corresponding to the identification data, a RFID reader detecting movement of the exhibition device according to the radio frequency signal, reading the identification data of the RFID tag, and outputting device status information indicating the movement and the identification data of the exhibition device, a central processing unit obtaining device name, movement duration and frequency, and multimedia information corresponding to the exhibition device according to the device status information, and a display device displaying the multimedia information corresponding to the exhibition device.

Another exemplary embodiment of an active marketing system for radio frequency identification (RFID) comprises a plurality of active marketing devices, each comprising an exhibition platform, an exhibition device disposed on the exhibition platform, a RFID tag on the exhibition device registering identification data corresponding to the exhibition device and outputting a radio frequency signal corresponding to the identification data, a RFID reader detecting movement of the exhibition device according to the radio frequency signal, reading the identification data of the RFID tag, and outputting device status information indicating the movement and the identification data of the exhibition device, a central processing unit obtaining a device name, movement duration and frequency and multimedia information corresponding to the exhibition device according to the device status information, a display device displaying the multimedia information corresponding to the exhibition device, and a server coupled to the active marketing devices, measuring movement duration and frequency corresponding to the exhibition device obtained by the central processing unit corresponding to the exhibition device.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a skeleton outward appearance of an active marketing device according to an embodiment of the invention;

FIG. 2A shows an embodiment of an arrangement of exhibition devices 104 in active marketing device 100;

FIG. 2B is a cross-section of FIG. 2A;

FIG. 3A shows another embodiment of an arrangement of exhibition devices 104 in active marketing device 100;

FIG. 3B is a cross-section of FIG. 3A;

FIG. 4 shows a skeleton outward appearance of an exhibition device according to an embodiment of the invention;

FIG. 5 is a skeleton block diagram of an active marketing device according to an embodiment of the invention;

FIG. 6A shows an arrangement of transceiver antenna 1081 in RFID reader 108 according to an embodiment of the invention;

FIG. 6B shows an arrangement of transceiver antenna 1081 in RFID reader 108 according to another embodiment of the invention;

FIG. 7 is a skeleton block diagram of an active marketing device according to another embodiment of the invention;

FIG. 8 is a skeleton block diagram of an active marketing device according to another embodiment of the invention;

FIG. 9 is a skeleton block diagram of an active marketing device according to another embodiment of the invention;

FIG. 10 is a skeleton block diagram of an active marketing device according to another embodiment of the invention;

FIG. 11 is a skeleton block diagram of an active marketing device according to another embodiment of the invention;

FIG. 12 is a skeleton block diagram of an active marketing device according to another embodiment of the invention;

FIG. 13 is a skeleton block diagram of an active marketing device according to another embodiment of the invention; and

FIG. 14 is a skeleton block diagram of an active marketing system according to an embodiment of the invention.

### DETAILED DESCRIPTION OF THE INVENTION

The following description is of the best-contemplated mode of implementing the invention. This description is made for the purpose of illustrating the general principles of the invention and should not be taken in a limiting sense. The scope of the invention is best determined by reference to the appended claims.

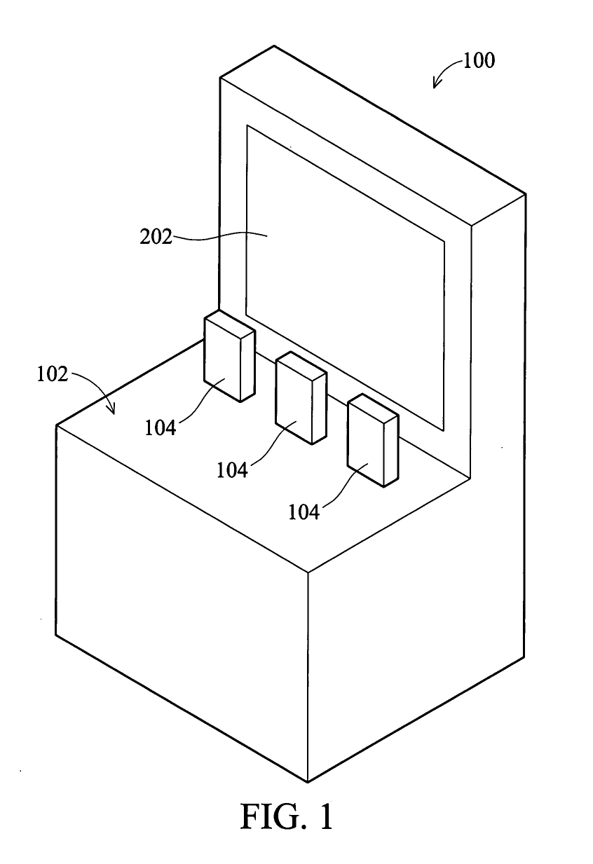

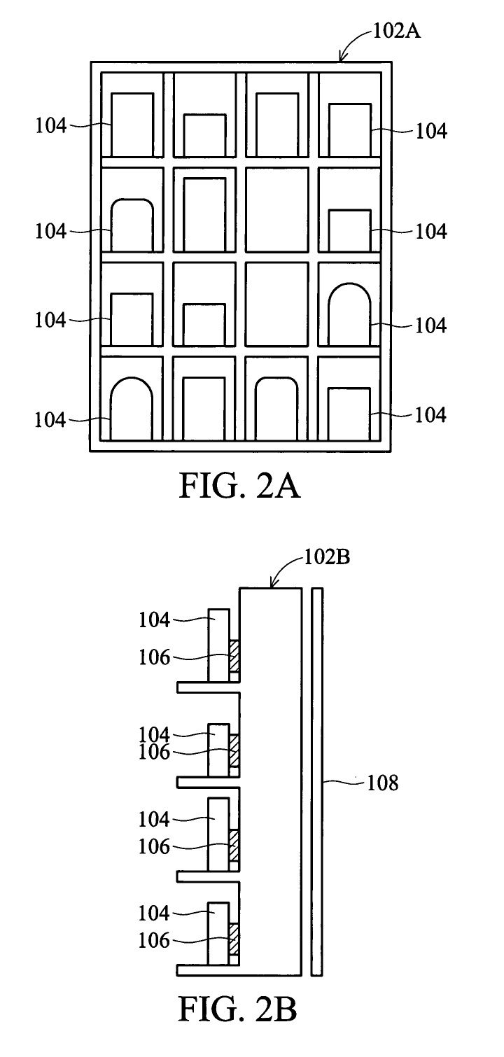

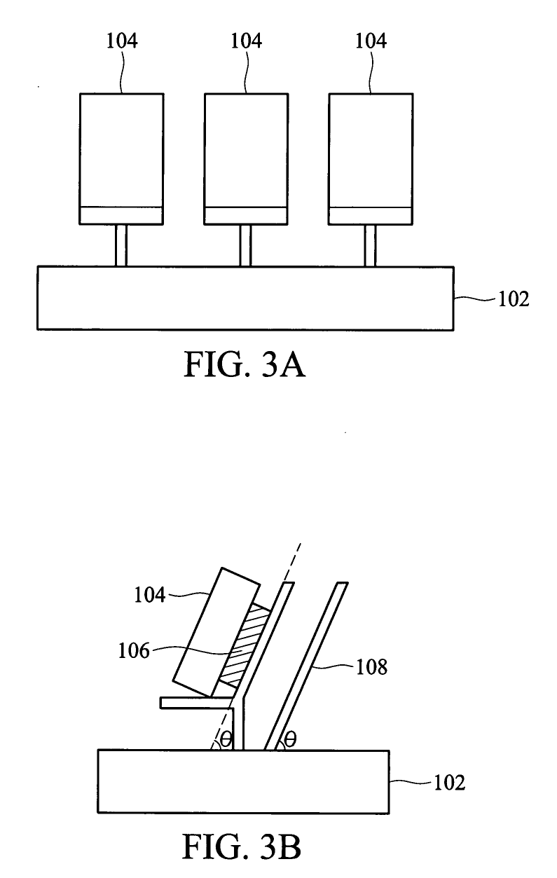

FIG. 1 shows a skeleton outward appearance of an active marketing device according to an embodiment of the invention. The active marketing device 100 according to an embodiment of the invention comprises an exhibition platform 102 holding a plurality of exhibition devices 104. In addition, the active marketing device according to an embodiment of the invention further comprises a display device 202. FIG. 2A shows an embodiment of an arrangement of exhibition devices 104 in active marketing device 100. As shown in FIG. 2A, a plurality of exhibition devices 104 are standing vertically or lying horizontally in the exhibition platform 102, a grid-type cabinet in this embodiment. FIG. 2B is a cross-section of FIG. 2A. As shown in FIG. 2B, exhibition devices 104 comprising a radio frequency identification (RFID) tag 106 are placed in one side of the grid-type cabinet, and a RFID reader 108 is installed on another side, reading the information response from the RFID tag 106. FIG. 3A shows another embodiment of an arrangement of exhibition devices 104 in active marketing device 100. As shown in FIG. 3A, a plurality of exhibition devices 104 are located on exhibition platform 102. FIG. 3B is a cross-section of FIG. 3A. As shown in FIG. 3B, exhibition devices 104 comprising RFID tag 106 are placed on exhibition platform 102 with an angle θ therebetween. In addition, a RFID reader 108 is installed on the other side of grid-type cabinet 102 with the angle θ to the exhibition platform 102 for reading the information response from the RFID tag 106.

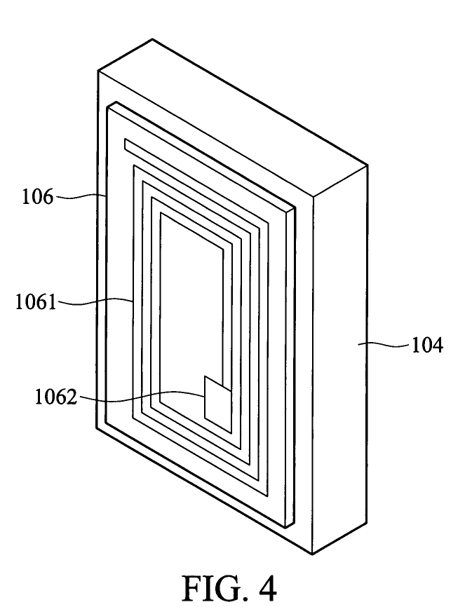

FIG. 4 shows a skeleton outward appearance of the exhibition device according to an embodiment of the invention. RFID tag 106 comprising coil 1061 and chip 1063 is attached to exhibition device 104. According to an embodiment of the invention, RFID tag 106 can be attached to the back of exhibition device 104. However, it is known in the art that RFID tag 106 can be located in or on the outer surface of the exhibition device 104 depending on the space requirement.

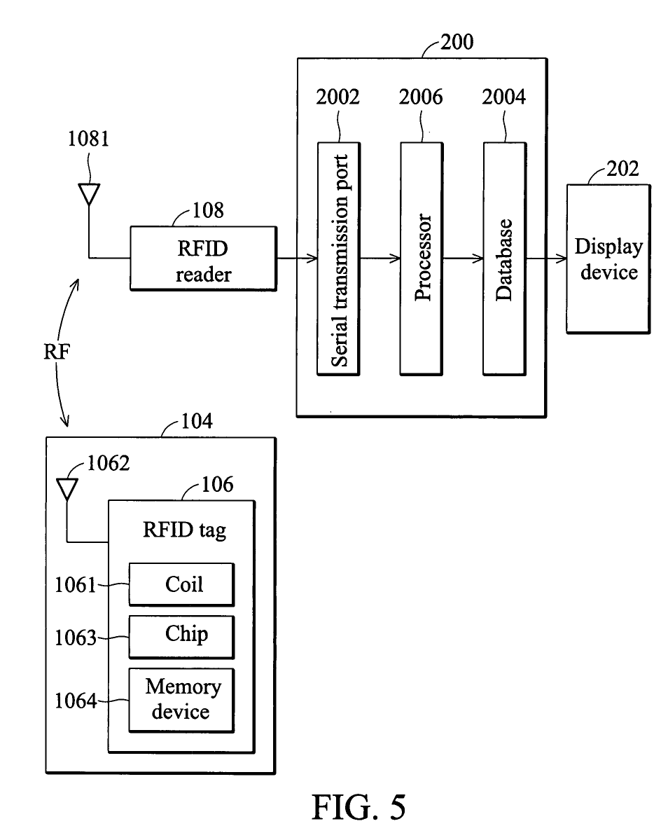

FIG. 5 is a skeleton block diagram of the active marketing device according to an embodiment of the invention. Exhibition device 104 comprises a RFID tag 106. RFID tag 106 comprises coil 1061, chip 1063, memory device 1064 registering identification data related to the exhibition device 104, and transceiver antenna 1062 outputting a RF signal corresponding to the identification data.

In addition, RFID tag 106 can be an active RFID tag or a passive RFID tag. The passive RFID actively returns the RF signal comprising its identification number in response to the induction of the electromagnetic wave from RFID reader 108.

The installed position of RFID tag 106 is within the range where the RFID reader 108 is able to induct. RFID reader 108 comprises transceiver antenna 1081. RFID reader 108 detects the movement of exhibition device 104 when the distance between RFID tag 106 and RFID reader 108 varies. In response to the detection of the movement of exhibition device 104, RFID reader 108 reads the identification data and the data registered in memory device 1064 corresponding to the RFID tag 106 of the moved exhibition device 104, and outputs corresponding device status information indicating the movement and the identification data. In the embodiments of the invention, the distance between RFID tag 106 and RFID reader 108 can be detected as the exhibition device 104 is removed away exhibition platform 102, or returned thereto. In this embodiment, one RFID tag 106 corresponds to one RFID reader 108.

Central processing unit 200 comprises serial port 2002, database 2004, and processor 2006. Serial port 2002 is electrically connected to RFID reader 108 for receiving device status information from RFID reader 108. In other embodiments, data can be transmitted between central processing unit 200 and RFID reader 108 by interfaces of near field communication (NFC), ZigBee wireless network, BlueTooth, universal serial bus (USB), TCP/IP, RS232, or RS485.

Database 2004 registers device names corresponding to each exhibition device 104 and the multimedia information corresponding to each exhibition device 104 corresponding to the device status information.

Processor 2006 obtains the device names and the multimedia information corresponding to the exhibition device 104 according to the device status information. In addition, device status information may comprise the movement duration and frequency of exhibition device 104, allowing processor 2006 to measure the movement duration and frequency of each exhibition device 104.

Display device 202 is electrically connected to central processing unit 200 through the interface such as RS232, IrDa (Infrared Data Association), VGA, DVI (digital visual interface), AV, or color difference interface, and displays the multimedia information corresponding to the exhibition device 104. According to an embodiment of the invention, the multimedia information may comprise video and audio advertisement of exhibition device 104. Thus, as RFID reader 108 detects the movement of exhibition device 104 with RFID tag 106, the detected identification number is transmitted to processor 2006 through serial port 2002. Processor 2006 searches the multimedia information corresponding to the detected identification number in database 2004, and transmits the multimedia information to display device 202. Thus, display device 202 simultaneously displays the multimedia information corresponding to the exhibition device 104 with the identification number.

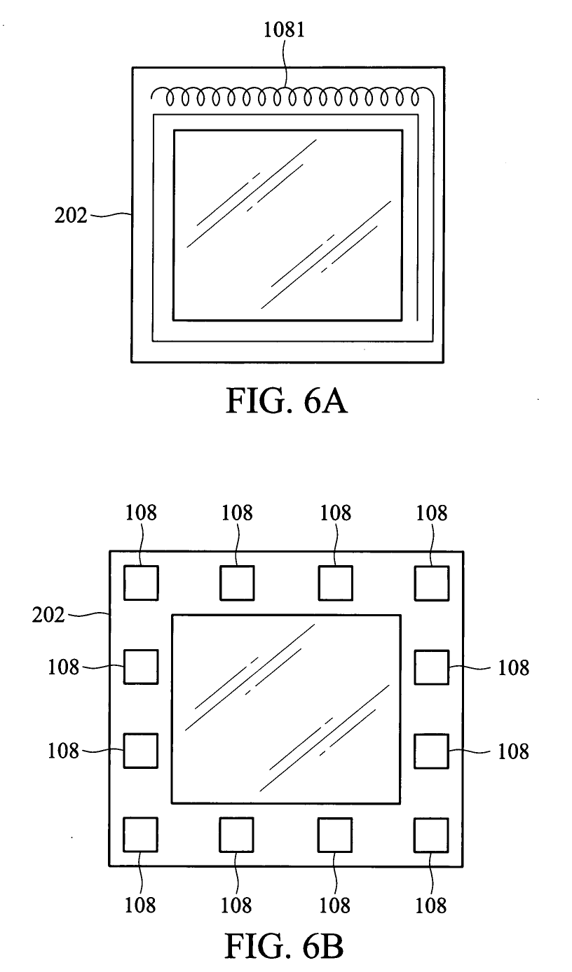

FIG. 6A shows an arrangement of transceiver antenna 1081 in RFID reader 108 according to an embodiment of the invention. As shown in FIG. 6A, transceiver antenna 1081 is located along the fringe of the screen side of display device 202. FIG. 6B shows an arrangement of transceiver antenna 1081 in RFID reader 108 according to another embodiment of the invention. As shown in FIG. 6B, a plurality of transceiver antennas 1081 are respectively located along the fringe of the screen side of display device 202.

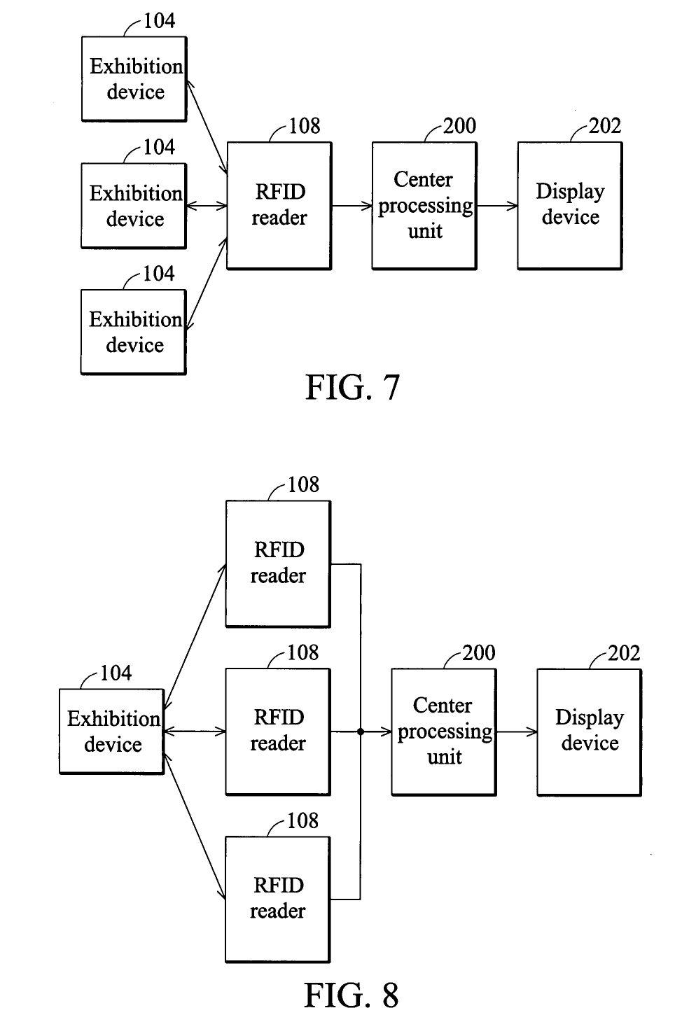

FIG. 7 is a skeleton block diagram of the active marketing device according to another embodiment of the invention. In FIG. 7, the elements pose approximate features and functions to FIG. 5 with the identical label, and the description of their functions is omitted to simplify the description. Note that the active marketing device shown in FIG. 7 uses single RFID reader 108 to detect a plurality of RFID tags 106 belonging to different exhibition devices 104. In an embodiment, RFID reader 108 may obtain information from the plurality of exhibition devices 104 in turns. Thus, as RFID reader 108 detects the movement of exhibition device 104 with RFID tag 106, the detected identification number is transmitted to processor 2006 through serial port 2002. Processor 2006 searches the multimedia information corresponding to the detected identification number in database 2004, and transmits the multimedia information to display device 202. Thus, display device 202 simultaneously displays the multimedia information corresponding to the exhibition device 104 with the identification number.

According to another embodiment of the invention, a plurality of exhibition devices 104 share single display device 202 to display the multimedia information corresponding to each exhibition device 104. Thus, as RFID reader 108 detects the movement of exhibition device 104 with RFID tag 106, the detected identification number is transmitted to processor 2006 through serial port 2002. Processor 2006 searches the multimedia information corresponding to the detected identification number in database 2004, and transmits the multimedia information to display device 202. Thus, display device 202 simultaneously displays the multimedia information corresponding to the exhibition device 104 with the identification number.

FIG. 8 is a skeleton block diagram of the active marketing device according to another embodiment of the invention. In FIG. 8, the elements pose approximate features and functions to FIG. 5 with the identical label, and the description of their functions is omitted to simplify the description. Note that the active marketing device shown in FIG. 8 uses a plurality of RFID readers 108 to detect single RFID tags 106 belonging to an exhibition device 104. In an embodiment, a plurality of RFID readers 108 may communicate with central processing unit 200 through a hub. In addition, detection range for exhibition device 104 is extended using a plurality of RFID readers 108. Thus, as a RFID reader 108 detects the movement of exhibition device 104 with RFID tag 106, the detected identification number is transmitted to processor 2006 through serial port 2002. Processor 2006 searches the multimedia information corresponding to the detected identification number in database 2004, and transmits the multimedia information to display device 202. Thus, display device 202 simultaneously displays the multimedia information corresponding to the exhibition device 104 with the identification number.

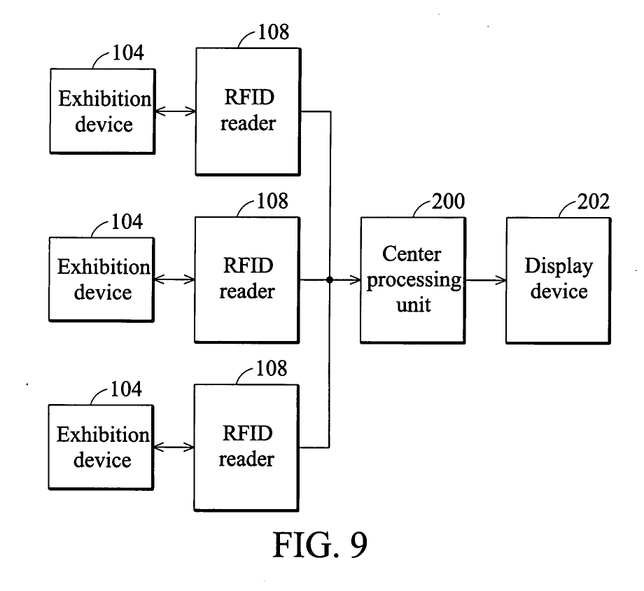

FIG. 9 is a skeleton block diagram of the active marketing device according to another embodiment of the invention. In FIG. 9, the elements pose approximate features, and functions to FIG. 5 with the identical label, and the description of their functions is omitted to simplify the description. Note that the active marketing device shown in FIG. 9 uses a plurality of RFID readers 108 to detect corresponding RFID tags 106 belonging to different exhibition devices 104. In an embodiment, a plurality of RFID readers 108 may communicate with central processing unit 200 through a hub. In addition, detection range for exhibition device 104 is extended using a plurality of RFID readers 108. In other embodiments, RFID readers 108 may detect the movement of any of exhibition devices 104, rather than single exhibition devices 104 only. Thus, as each RFID reader 108 detects the movement of exhibition device 104 with RFID tag 106, the detected identification number is transmitted to processor 2006 through serial port 2002. Processor 2006 searches the multimedia information corresponding to the detected identification number in database 2004, and transmits the multimedia information to display device 202. Thus, display device 202 simultaneously displays the multimedia information corresponding to the exhibition device 104 with the identification number.

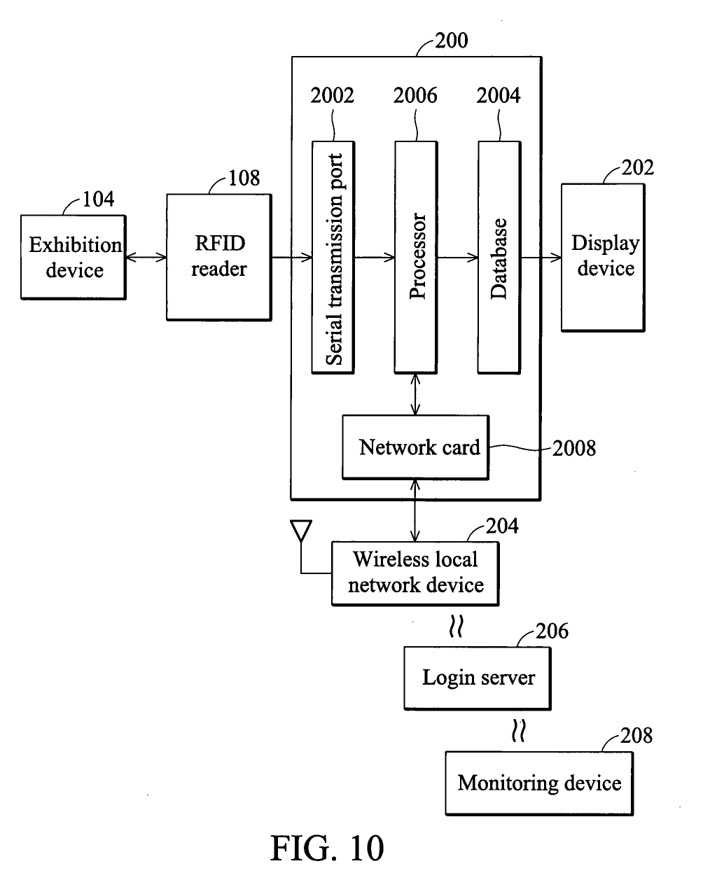

FIG. 10 is a skeleton block diagram of the active marketing device according to another embodiment of the invention. In FIG. 10, the elements pose approximate features and functions to FIG. 5 with the identical label, and the description of their functions is omitted to simplify the description. In this embodiment, central processing unit 200 may further comprise network card 2008. Network card 2008 is electrically connected to wireless local network device 204. Through network card 2008, central processing unit 200 may login server 206 and transmit the device status information comprising the movement duration and frequency of each exhibition device 104 to server 206.

Surveillance device 208 logs into server 206 through a communication network to obtain the device status information comprising the movement duration and frequency of each exhibition device 104. The communication network can be an Internet, Global System For Mobile Communications (GSM), General Packet Radio Service (GPRS), Code Division Multiple Access (CDMA), Wideband Code Division Multiple Access (WCDMA), High-Speed Downlink Packet Access (HSDPA), Worldwide Interoperability for Microwave Access (WiMAX), or ZigBee interface.

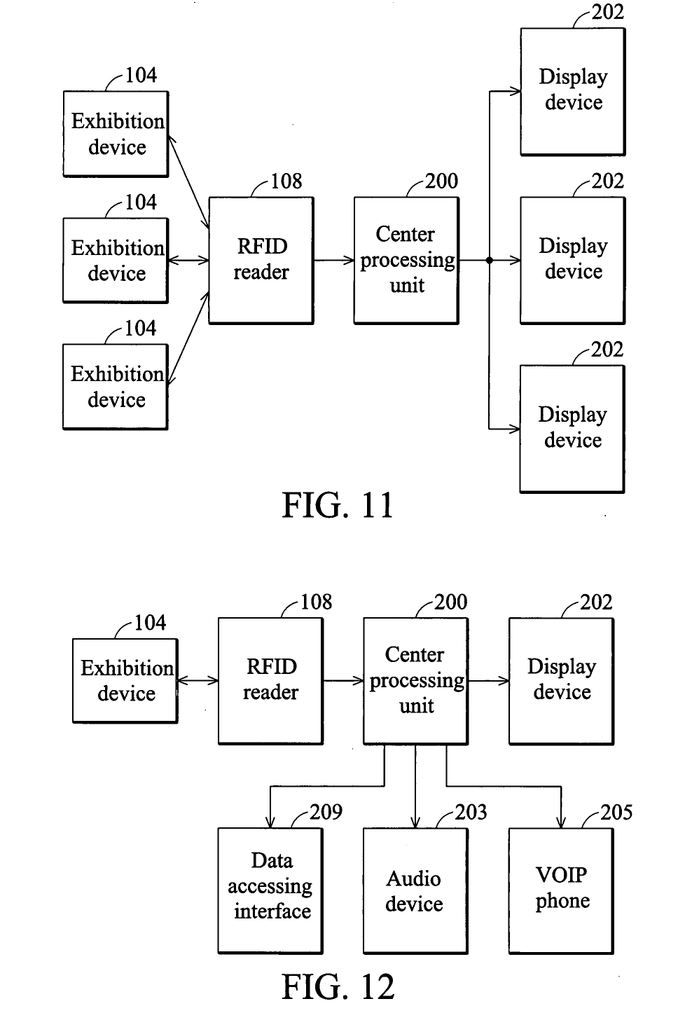

FIG. 11 is a skeleton block diagram of the active marketing device according to another embodiment of the invention. In FIG. 11, the elements pose approximate features and functions to FIG. 5 with the identical label, and the description of their functions is omitted to simplify the description. Note that the active marketing device shown in FIG. 11 uses a plurality of display devices 202 to display multimedia information corresponding to each exhibition device 104. Thus, as RFID reader 108 detects the movement of a specific exhibition device 104 with RFID tag 106, the detected identification number is transmitted to processor 2006 through serial port 2002. Processor 2006 searches the multimedia information corresponding to the detected identification number in database 2004, and transmits the multimedia information to display device 202. Thus, display device 202 simultaneously displays the multimedia information corresponding to the exhibition device 104 with the identification number. In addition, as the movements of a plurality of exhibition devices 104 are detected, the corresponding display devices 202 display the multimedia information corresponding to the detected exhibition devices 104 respectively.

In addition, according to another embodiment of the invention, display device 202 further comprises an interactive device for interaction with users. Display device 202 can be an LCD touch panel. Users can select their interesting multimedia information of a specific exhibition device from database 2004 using the LCD touch panel, and acquire the multimedia information from display device 202.

FIG. 12 is a skeleton block diagram of the active marketing device according to another embodiment of the invention. In FIG. 12, the elements pose approximate features and functions to FIG. 5 with the identical label, and the description of their functions is omitted to simplify the description. In this embodiment, the active marketing device according to the invention further comprises a voice over IP (VOIP) phone 205 for customers to communicate with a remote-end service center. According to an embodiment of the invention, the remote-end service center can be a call center of the product or an information center of the hyper market. In an embodiment, users can control the VOIP phone 205 using the LCD touch panel of display device 202. For example, the LCD touch panel of display device 202 may provide real-person voice service. A user can talk with the remote-end service center when enabling the voice service item. In another embodiment, the active marketing device according to the invention further comprises an audio device 203 for broadcasting audio advertisement. The audio device 203 can be mounted on display device 202 or separated from display device 202. In addition, the active marketing device according to the invention may further comprise a data accessing interface 209 for downloading information related to exhibition device 104 by users.

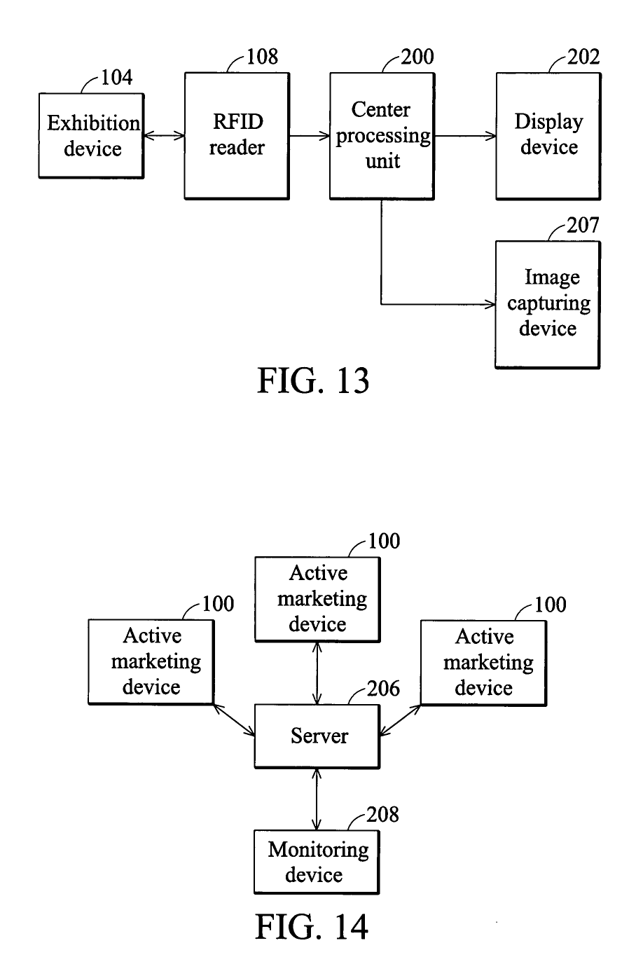

FIG. 13 is a skeleton block diagram of the active marketing device according to another embodiment of the invention. In FIG. 13, the elements pose approximate features and functions to FIG. 5 with the identical label, and the description of their functions is omitted to simplify the description. In this embodiment, the active marketing device according to the invention further comprises an image capturing device 207 for monitoring the environment around the active marketing device by the remote-end service center.

FIG. 14 is a skeleton block diagram of the active marketing system according to an embodiment of the invention. As shown in FIG. 14, each active marketing device 100 can respectively log into server 206 and transmit the registered information to server 206 through communication network. Thus, server 206 connects to the active marketing devices 100 through internet, which can be Ether net or wireless local area network (LAN), and active marketing devices 100 transmit data to server 206 at a predetermined time or real-timely. Server 206 calculates the movement duration and frequency of each exhibition device 104 according to the received data. In an embodiment of the invention, server 206 may be installed in one of the active marketing devices 100.

For the user at the surveillance device 208 to obtain device status information about each exhibition device 104, surveillance device 208 logs into server 206 through communication network to obtain the device status information. The device status information may comprise the movement duration and frequency of exhibition device 104. Thus, the popularity of exhibition devices 104 can be obtained according to the device status information, and used as a feedback of product exhibition.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An active marketing device for radio frequency identification (RFID), comprising:
an exhibition platform;
an exhibition device disposed on the exhibition platform;
a RFID tag on the exhibition device registering identification data corresponding to the exhibition device, and outputting a radio frequency signal corresponding to the identification data;
a RFID reader detecting movement of the exhibition device according to the radio frequency signal, reading the identification data of the RFID tag, and outputting device status information indicating the movement and the identification data of the exhibition device;
a central processing unit obtaining a device name, movement duration and movement frequency, and multimedia information corresponding to the exhibition device according to the device status information; and
a display device displaying the multimedia information corresponding to the exhibition device.

2. The active marketing device as claimed in claim 1, further comprising a surveillance device gaining the access to the movement duration and the movement frequency of the exhibition device through a communication network.

3. The active marketing device as claimed in claim 1, wherein the central processing unit comprises:
a serial port receiving the device status information;
a database registering the device name of the exhibition device and the multimedia information corresponding to the exhibition device; and
a processor obtaining the device name and the multimedia information corresponding to the exhibition device according to the device status information, and measuring movement duration and the movement frequency of the exhibition device.

4. The active marketing device as claimed in claim 1, wherein the multimedia information comprises video and audio advertisement corresponding to the exhibition device.

5. The active marketing device as claimed in claim 1, wherein the display synchronously displays the multimedia information corresponding to the exhibition device when the exhibition device is removed away the RFID reader.

6. The active marketing device as claimed in claim 1, wherein the display synchronously displays the multimedia information corresponding to the exhibition device when the exhibition device approaches the RFID reader.

7. The active marketing device as claimed in claim 1, wherein the central processing unit comprises a network card for internet connection.

8. The active marketing device as claimed in claim 2, wherein the surveillance device gains the access to the movement duration and the movement frequency of the exhibition device through an internet.

9. The active marketing device as claimed in claim 4, further comprising an audio device broadcasting the audio advertisement.

10. The active marketing device as claimed in claim 3, wherein the display device further comprises an interactive device for receiving input information, obtaining the multimedia information corresponding to the input information from the database, and displaying the multimedia information through the display device.

11. The active marketing device as claimed in claim 10, wherein the display device is a liquid crystal display touch panel.

12. The active marketing device as claimed in claim 1, further comprising a voice over IP phone for communicating with a remote-end service center.

13. The active marketing device as claimed in claim 2, wherein the communication network transmits data through an interface of an Internet, Global System For Mobile Communications (GSM), General Packet Radio Service (GPRS), Code Division Multiple Access (CDMA), Wideband Code Division Multiple Access (WCDMA), High-Speed Downlink Packet Access (HSDPA), Worldwide Interoperability for Microwave Access (WiMAX), or ZigBee interface.

14. The active marketing device as claimed in claim 1, wherein the RFID tag is an active RFID tag or a passive RFID tag.

15. The active marketing device as claimed in claim 1, further comprising a data access interface for downloading information related to the exhibition device.

16. An active marketing system for radio frequency identification (RFID), comprising:
a plurality of active marketing devices, each comprising:
an exhibition platform;
an exhibition device disposed on the exhibition platform;
a RFID tag on the exhibition device registering identification data corresponding to the exhibition device, and outputting a radio frequency signal corresponding to the identification data;
a RFID reader detecting movement of the exhibition device according to the radio frequency signal, reading the identification data of the RFID tag, and outputting device status information indicating the movement and the identification data of the exhibition device;
a central processing unit obtaining a device name, movement duration and movement frequency, and multimedia information corresponding to the exhibition device according to the device status information; and
a display device displaying the multimedia information corresponding to the exhibition device; and
a server coupled to the active marketing devices, measuring movement duration and the movement frequency corresponding to the exhibition device obtained by the central processing unit corresponding to the exhibition device.

17. The active marketing system as claimed in claim 16, further comprising a surveillance device gaining the access to the movement duration and the movement frequency of the exhibition device through a communication network.

18. The active marketing system as claimed in claim 16, wherein the central processing unit comprises:
a serial port receiving the device status information;
a database registering the device name of the exhibition device and the multimedia information corresponding to the exhibition device; and
a processor obtaining the device name and the multimedia information corresponding to the exhibition device according to the device status information, and measuring movement duration and the movement frequency of the exhibition device.

19. The active marketing system as claimed in claim 16, wherein the multimedia information comprises video and audio advertisement corresponding to the exhibition device.

20. The active marketing system as claimed in claim 16, wherein the central processing unit comprises a network card for connecting to an internet.

21. The active marketing system as claimed in claim 17, wherein the surveillance device obtains the movement duration and the movement frequency of the exhibition device through an internet.

22. The active marketing system as claimed in claim 18, further comprising an audio device broadcasting the audio advertisement.

23. The active marketing system as claimed in claim 18, wherein the display device further comprises an interactive device for receiving input information, obtaining the multimedia information corresponding to the input information from the database, and displaying the multimedia information through the display device.

24. The active marketing system as claimed in claim 23, wherein the display device is a liquid crystal display touch panel.

25. The active marketing system as claimed in claim 16, further comprising a voice over IP phone for communicating with a remote-end service center.

26. The active marketing system as claimed in claim 16, wherein the server 206 is installed in one of the active marketing devices.

27. The active marketing system as claimed in claim 17, wherein the communication network transmits data through an interface of an Internet, Global System For Mobile Communications (GSM), General Packet Radio Service (GPRS), Code Division Multiple Access (CDMA), Wideband Code Division Multiple Access (WCDMA), High-Speed Downlink Packet Access (HSDPA), Worldwide Interoperability for Microwave Access (WiMAX), or ZigBee interface.

28. The active marketing system as claimed in claim 16, wherein the RFID tag is an active RFID tag or a passive RFID tag.

29. The active marketing system as claimed in claim 16, further comprising a data access interface for downloading information related to the exhibition device.
